(19) United States
(12) Patent Application Publication
(10) Pub. No.: US 2003/0061192 A1
(43) Pub. Date: Mar. 27, 2003

(54) Method and system for communicating lock information

(76) Inventors: Edward J. McGunn, Chicago, IL (US); James Ivey, Posen, IL (US); Danny R. Hardy JR., New Lenox, IL (US)

Correspondence Address: WOOD, PHILLIPS, VAN SANTEN,, CLARK & MORTIMER, SUITE 3800, 500 WEST MADISON STREET, CHICAGO, IL, 60661, US

(21) Appl. No.: 09/961,454

(22) Filed: Sep. 24, 2001

(51) Int. Cl. G06F 7/00

(52) U.S. Cl. 707/1

(57) ABSTRACT

The present invention discloses a system for communicating lock information comprising a first terminal (102) coupled to a communication network (112); a database (107) associated with the first terminal for storing said lock information; and second terminal (114) in communication with said first terminal by way of said communication network for accessing the lock information. A method for communicating lock information stored in a remote database is also disclosed. The method comprises steps of providing (202) information related to a lock; storing (204) the information in a database remote from the lock; and providing (206) access by an end user to the information in the database by way of a computer network. A method according to an alternate embodiment is disclosed for communicating lock information stored in a remote database comprising steps of accessing (602) computer network; providing (604) access information necessary to access the remote database; and receiving (614) the lock information from the database.

### FIELD OF THE INVENTION

The present invention relates to locks, and more particularly, to a method and system for generating, storing and communicating lock information from a database to a user of a lock.

### BACKGROUND OF THE INVENTION

With the increasing use of locks, it is becoming more difficult to remember lock combinations, and in particular combinations for electronic locks which can have more complex combinations. Existing locks are currently shipped with a “pre-programmed” standard combination, such as “1, 2, 3, 4, 5, 6.” A user of the lock can then reprogram the lock if desired. When locks are installed in devices such as safes, they are often programmed by the manufacturer of the safe. The safe manufacturer can program the lock with a random combination, or with a combination desired by a customer. Various lock manufacturers have certain criteria which must be met in selecting a combination for the lock. Therefore, it is necessary for each programmer working for the manufacturer to be aware of the rules in selecting a combination for a lock when installing a particular lock in a safe.

When the lock is programmed and the safe is shipped to a customer, a printed combination card is often provided with the safe so that the customer can open the safe. However, these combination cards are often lost and there is no record of the combination for the safe. Further, when there is a need to change the combination on the lock, no further record of the combination is typically maintained. In the case of combination locks maintained by a corporation, there may be a need to change the combinations frequently for security reasons. Also, a corporation may have many locks, making it very difficult to maintain records of all of the combinations.

Accordingly, there is a need for a method and system for communicating lock combinations and other lock information stored in a remote database to a user of a lock by way of a communication network.

### SUMMARY OF THE INVENTION

The present invention eliminates the problems of selecting combinations for lock, programming digital lock combinations, and storing and retrieving these combinations and other information, but accommodates the desire of a lock owner to select a predetermined combination. The present invention further uses the parameters provided by the different lock manufacturers to select acceptable lock combinations. Once a programmer enters the serial number, model number, and the minimal lock parameters, the system of the present invention will automatically generate a pseudo-random combination for the lock, store it, and print a combination card for the potential owner of the lock. If in the future this information needs to be viewed by properly assigned personnel or a product owner, the system and method of the present invention will allow access to this information.

According to one aspect of the invention, a programmer selling a lock (or a device incorporating a lock) preferably enters a serial number, a model number, selects a type of lock, and selects the proper configuration of the lock within the specs of the lock manufacturer. The programmer can then select a “Generate Codes” option to generate the combination code(s). Each code preferably has an “Override Code” option that can be selected, if desired. This will allow the programmer to change the combination code to a code specified by the user. The programmer may also need to select the location of the lock on the safe from a list of possible locations. The programmer can then either select the “Save” option to save the new lock information, or may select “Re-Print” in order to reprint the data from a previous entry. If the user had selected “Save,” it will save this information to a computer, such as a SQL based server, and print the combination cards. If the user selected “Re-Print,” the user will preferably be prompted with a new window that will allow them to choose the lock whose combination data they want to re-print. Once this lock is selected, the programmer will preferably press the “Print” button in order for it to print the combination card to the printer.

According to another aspect of the invention, a user of a lock can retrieve lock information by using a computer, such as by simply accessing a web browser. The user preferably addresses a specified URL location and enters a full or partial serial number. The user then scrolls down the list of results until the desired lock is identified. Upon selecting a “Display” link, a new web browser window will preferably open and display the combination data in a simple and easy to use format. For an advanced search, the user can select an “Advanced Search” link to search based on a full or partial serial number, the date information related to the lock was entered into the system, lock type or some other criteria. Upon selecting the “Search” option to display the search results, the user can scroll down the list until the desired lock is shown. Then the user can select the “Display” link and a new browser window will preferably open and display the lock data in a simple and easy to use format. The user will preferably be able to sort the results of an advanced search by serial number, date entered, or type of lock.

Accordingly, it is an object of the present invention to provide a method and system for storing a lock combination and other information related to a lock in a remote database accessible by a user of a lock by way of a communication network.

It is a further object of the present invention to provide a system and method to provide access by a user of a lock to a remote database having lock information.

It is a further object of the present invention to communicate a lock combination and/or other lock information from a remote database to a lock user by way of a communication network.

It is a further object of the present invention to provide a system and method to maintain a centralized database of lock information accessible from a plurality of users at a plurality of remote locations.

It is a further object of the present invention to provide a system and method to enable changing and/or updating of lock information by a user of a lock from a remote location.

It is a further object of the present invention to provide a system and method for automatically generating a combination for a lock that is consistent with lock combination parameters established by a manufacturer.

Finally, it is an object of the present invention to provide a system and method of providing a service for storing and/or maintaining a database of lock combinations in a remote location accessible by a user of a lock in exchange for compensation, such as a usage or subscription fee.

### BRIEF DESCRIPTION OF THE DRAWINGS

The novel features believed characteristic of the invention are set forth in the appended claims. The invention itself however, as well as the preferred mode of use, further objects and advantages thereof, will best be understood by reference to the following detailed description of an illustrative embodiment when read in conjunction with the accompanying drawings, wherein:

FIG. 1 is a block diagram showing a system for generating, storing and communicating lock information according to the present invention;

FIG. 2 is a flow chart showing a method for communicating lock information according to the present invention;

FIG. 3 is a flow chart showing a method for generating a lock combination for storage in a database according to the present invention;

FIG. 4 is a flow chart showing an alternate embodiment for a method of generating a lock combination for storage in a database according to the present invention;

FIG. 5 is a flow chart showing a method for accessing lock information by a user according to the present invention;

FIG. 6 is flow chart showing an alternate embodiment for a method of accessing lock information by a user according to the present invention; and

FIG. 7 is a flow chart showing a business method of maintaining and operating a database having lock information accessible to a user from a remote location.

### DETAILED DESCRIPTION OF THE PREFERRED EMBODIMENT

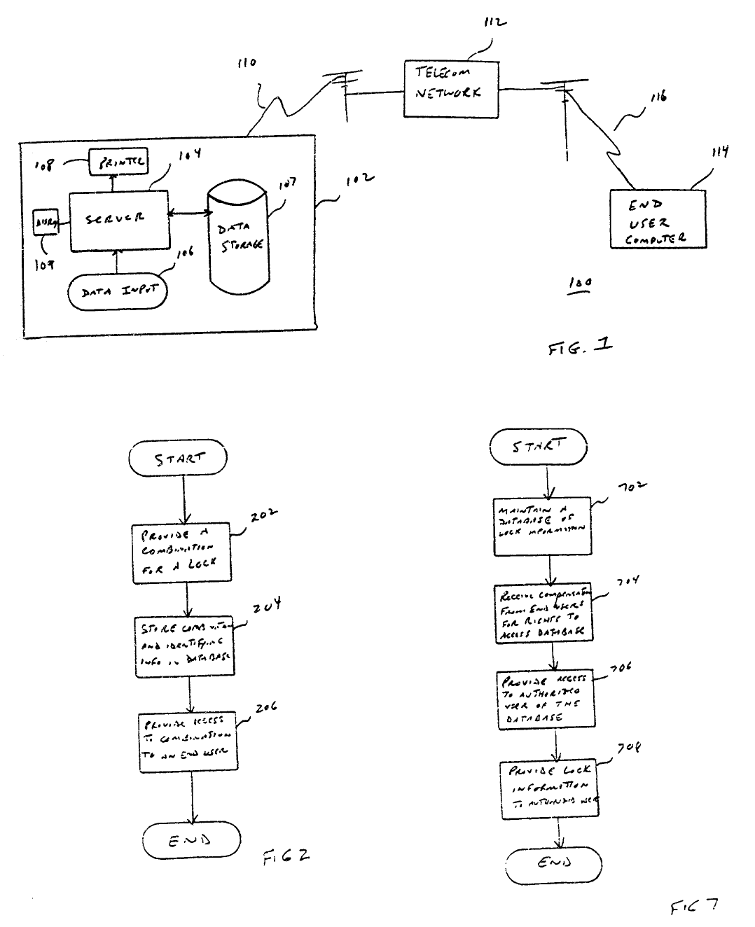

Turning now to FIG. 1, a block diagram shows a system for generating, storing and communicating lock information to an end user according to the present invention. System 100 includes a computer system 102 comprising a server 104, a data input device 106, a data storage device 107, a printer 108 and a display 109. Computer system 102 is coupled by communication link 110 to a telecommunications network 112. As would be understood by one skilled in the art of communications, a variety of telecommunications networks could be employed to transmit information from computer system 102. Telecommunication network 112 could comprise any fixed or wireless communication network, including any analog or digital network, and could include wireless or wireline hubs, or a combination thereof, and would preferably include access to a global communication network such as the Internet. An end user computer 114 is also coupled to the telecommunications network 112 by way of a communication link 116. Communication link 116 also could be a wireless or wire line communication link. Although one end user computer is shown, a plurality of computers, at one location or a plurality of locations, could be coupled to telecommunications network 112.

Turning now to FIG. 2, a flow chart shows a method of communicating lock information to a user. In particular, a lock combination is provided to a lock in a step 202. As will be described in more detail in reference to the remaining figures, the combination could be provided randomly or at the request of a customer, and could be provided at any location, such as at the site of the manufacturer or at the end user site. The combination is then stored, preferably along with other information for identifying the lock, in a database at a step 204. Preferably, the database is at a remote location and maintained by a secure entity. Finally, access is provided to an end user to obtain information such as the combination for the lock at a step 206.

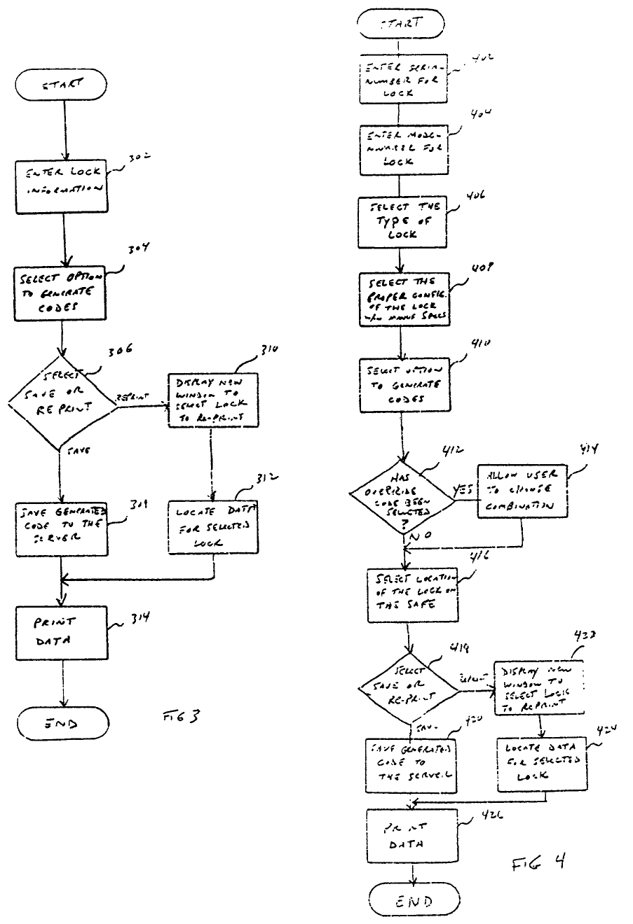

Turning now to FIG. 3, a method of generating a lock combination for storage in a database according to the present invention is shown. Lock information is initially entered preferably by a programmer into the database at a step 302. The lock information could include any type of information associated with the lock, such as the serial number, the manufacturer of the lock, the date of manufacture of the lock, the type of lock, a master code, or other specific information related to the use of the lock, such as the location of the lock on a safe, for example. A master code allows a user to provide (or deny) access to certain users or change restricted features of a lock. After all the information is entered, it is possible to select an option to generate a lock combination or code at a step 304. The generated combination preferably could be based upon the lock information, such as manufacturer's specifications. For example, a manufacturer may not allow a number to be within a certain range of the next number in the combination. If a random number generator generates a number which does not satisfy the condition, the number will automatically be discarded and a new number will be generated.

The programmer entering the data can then opt to select a “Save” or “Reprint” option at a step 306. If the “Save” option is selected, the generated combination is saved at a step 308, such as at data storage device 107 of computer system 102. If the person opts to “Reprint,” a new window to select a lock data to be reprint is displayed at a step 310. The computer system will locate the data for a selected lock at a step 312. After saving the data at a step 308 or locating the data for a selected lock at a step 312, the data is printed on a card by the printer 108 at a step 314. This data can be provided to an end user with the lock from the manufacturer applying the lock, such as a safe manufacturer installing the lock.

Turning now to FIG. 4, a more detailed flow chart shows a method according to an alternate embodiment of generating a lock combination for storage in a database according to the present invention. A programmer entering data for storage in a computer system enters the serial number for the lock at a step 402. The programmer also enters the model number for the lock at a step 404, and selects the type of a lock at a step 406. Depending upon the lock selected, the programmer will then select the proper configuration of the lock within the manufacturer's specifications at a step 408. For example, the programmer could select a certain number of users, a master code, etc.

The programmer can then select an option to generate a combination at a step 410. Once the combination is generated, the user can then decide whether to override the combination at a step 412. If the programmer decides to override the combination, the programmer can change the combination at a step 414. Preferably a new window would appear on the display to prompt the programmer to enter the desired combination. Such a feature is beneficial in the event that a customer selects a unique combination to be used for the lock. The programmer may also change other information which may be changed, such as a master code, as desired. However, certain manufacturers may not allow a master code to be changed and therefore, the method of the present invention would prevent the change.

After the code has been generated, the programmer selects a location for the lock on the safe at a step 416. The programmer can then elect to save or reprint at a step 418. If the programmer selects “Save”, the generated combination is saved in a database at a step 420. If the programmer selects “Reprint”, a new window to select a lock to reprint is displayed at a step 422, and the data for the selected lock is located at a step 424. The computer network then prints the saved data or the data selected to be reprinted at a step 426.

The methods described in FIG. 3 and FIG. 4 could be employed on a variety of computer systems, such as a system having Windows NT 4.0 or later (including Windows 2000) on a Microsoft SQL Server v7.0 or later (including Microsoft SQL Server 2000) operating on a TCP/IP network, for example. A program incorporating the method of the present invention could be accessed directly on a terminal associated with computer system 102, for example, by selecting a “shortcut” on display 109. Also, “pop-down” menu options and windows could be employed to lead a programmer through the program.

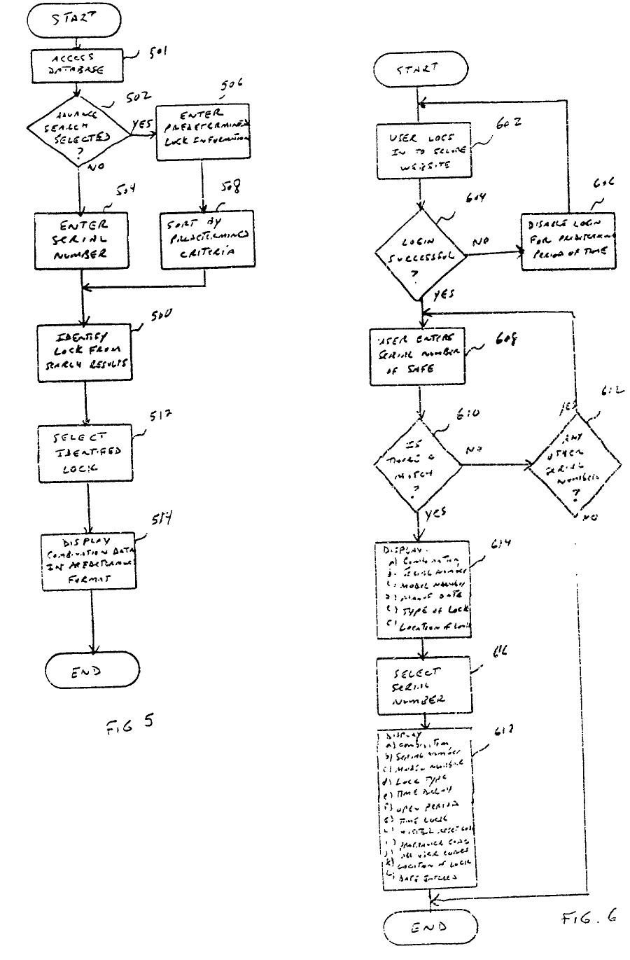

Turning now to FIG. 5, a flow chart shows a method of accessing lock information by an end user from a database according to the present invention. The end user accesses a program on a computer for communicating with the remote database at a step 501. The program implementing the method of the present invention preferably could access the database by automatically enabling a web browser to locate an appropriate web page. The user first determines whether an advanced search should be conducted at a step 502. If an advanced search is not necessary, the user enters a serial number at a step 504. The serial number could be a full serial number or a partial serial number depending upon the needs of the user.

If an advanced search is desired, the user enters predetermined lock information at a step 506. For example, the first two letters of a serial number could be a unique to a particular customer. By entering a partial serial number of the two digit code of the company, all locks for the company will be displayed. The system will sort the locks by a predetermined criteria at a step 508. The user can then identify the lock from the search results (if multiple locks are discovered) at a step 510, and select the identified lock at a step 512. The combination and other relevant information for the lock will be displayed in a predetermined format at a step 514.

Turning now to FIG. 6, a flow chart shows a method for accessing lock information by a user from a database according to an alternate embodiment of the present invention. A user preferably logs into a secure website at a step 602. If the computer network having the database determines that the log-in is not successful at a step 604, the access to the database may be disabled for a predetermined period of time at a step 606. For example, if three log-in attempts were unsuccessful, the computer may disable access to the network by that user for a predetermined period of time, such as three hours. The disabling feature could be provided by standard security software, such as security software offered by Verisign, Inc.

If the log-in is successful, the user then enters a serial number or a partial serial number of a safe at a step 608. If the computer network determines that there is no match with the serial number of the safe, the computer prompts the user to determine whether there are any additional serial numbers which are desired to be searched at a step 612. If there is a match with a serial number at step 610, the computer displays the combination, the serial number, the model number, the manufacture date, the type of lock, the location of the lock, or any other relevant information at a step 614.

When the user selects the serial number (e.g. double clicking on the serial number) at a step 616, then additional information regarding the lock is preferably displayed. For example, the combination, the serial number, the model number, the lock type, a time delay (a time after which the correct code is entered before the safe can be opened), an open period (the amount of time the safe can remain open), a time lock (the time period during which a lock can be opened), a master reset code, a programmer code, all user codes, the location of the lock on the safe, and the date the information was entered in the database is displayed at a step 618.

Although the method of the present invention could employed on any computer, such a method could be employed on a computer having the following requirements: Microsoft Windows 95, 98, ME, NT, or 2000, 64 MB of RAM, 10 MB of Hard Drive Space, a TCP/IP network and a Microsoft Windows compatible printer.

Turning now to FIG. 7, a flow chart shows a business method of maintaining a database having lock information accessible by end users according to the present invention is shown. A company maintains a database of lock information at a step 702. The company receives compensation from end users for the right to access the database at a step 704. The compensation could be any type of consideration, such as a subscription fee, a “per use” fee, or some other type of value to the company. In turn, the company provides access to authorized users of the database at a step 706, and provides lock information to authorized users at a step 708.

Although the invention has been described with reference to a specific embodiment, this description is not meant to be construed in a limiting sense. Various modifications of the disclosed embodiment as well as alternative embodiments of the invention will become apparent to persons skilled in the art upon reference to the description of the invention. For example, although a remote location in the description of the preferred embodiment shows a physically remote location, the remote location could be in the same building or area. Similarly, although a telecom network is shown, any type of communication network could be employed, such as a local area network, an in-building wireless network, an intranet application, etc. It is therefore contemplated that the appended claims will cover any such modifications or embodiments that fall within the true scope of the invention.

1. A method of communicating lock information stored in a remote database, said method comprising the steps of:
providing information related to a lock;
storing said information in said remote database; and
enabling access by an end user to said information in said database by way of a computer network.

2. The method of claim 1 wherein the step of providing information related to a lock comprises generating a random number combination.

3. The method of claim 2 further comprising a step of enabling the override of said random number combination if said random number combination is inconsistent with parameters associated with said lock.

4. The method of claim 1 further comprising a step of entering lock information associated with said lock in said remote database.

5. The method of claim 4 wherein said lock information comprises information selected from the group consisting of:
a combination;
a serial number;
a model number;
a lock type;
a time delay;
an open period;
a time lock;
a master reset code;
a programmer code;
user codes;
the location of the lock on the safe; and
the date the information was entered in the database.

6. The method of claim 1 wherein the step of providing information related to a lock comprises manually entering a predetermined combination.

7. The method of claim 1 further comprising a step of updating a combination in said remote database with a new combination received from said end user of said lock.

8. The method of claim 1 wherein said step of enabling access to an end user comprises providing a web page accessible by said end user.

9. The method of claim 1 further comprising a step of providing security software requiring log-in information.

10. The method of claim 1 further comprising a step of providing information relevant to a predetermined lock to an end user.

11. A method of communicating lock information stored in a remote database, said method comprising the steps of:
entering information related to a predetermined lock;
generating a combination for said predetermined lock;
storing said information and combination in said remote database; and
enabling access by an end user to said combination and information by way of a computer network.

12. A method of generating a lock combination to be stored in a database, said method comprising the steps of:
providing information related to a lock;
generating a combination for said lock, said combination being consistent with parameters of said lock; and
storing said information and said combination in said database.

13. The method of claim 12 wherein the step of generating a combination comprises generating a random number combination.

14. The method of claim 12 further comprising a step of storing comprises storing said information and combination in a remote database.

15. The method of claim 12 further comprising a step of entering lock information associated with said lock in said database.

16. The method of claim 15 wherein said lock information comprises information selected from the group consisting of:
a serial number;
a model number;
a lock type;
a time delay;
an open period;
a time lock;
a master reset code;
a programmer code;
user codes;
the location of the lock on the safe; and
the date the information was entered in the database.

17. The method of claim 12 further comprising a step of updating a combination in said database with a new combination received from said end user of said lock and storing said updated combination.

18. The method of claim 12 further including a step of enabling access to an end user by providing a web page accessible by said end user.

19. The method of claim 12 further comprising a step of providing security software requiring log-in information.

20. The method of claim 12 further comprising a step of providing information relevant to a predetermined lock to an end user.

21. A method of communicating lock information stored in a remote database, said method comprising the steps of:
accessing a computer network;
providing access information necessary to access said remote database; and
receiving said lock information from said database.

22. The method of claim 21 wherein said step of accessing a computer network comprises accessing a web page associated with a provider of a lock.

23. The method of claim 21 wherein said step of providing access information comprises providing log-in information specific to an end user.

24. The method of claim 21 wherein said step of receiving said lock information comprises receiving a lock combination.

25. The method of claim 21 wherein said steps of receiving said lock information comprises receiving information selected from the group consisting of:
a combination;
a serial number;
a model number;
a lock type;
a time delay;
an open period;
a time lock;
a master reset code;
a programmer code;
user codes;
the location of the lock on the safe; and
the date the information was entered in the database.

26. The method of claim 21 further comprising a step of updating a combination for a predetermined lock with a new combination.

27. The method of claim 21 wherein said step of providing access information comprises providing log-in information necessary to access said remote database.

28. A method of communicating a lock combination stored in a remote database, said method comprising the steps of:
accessing a remote computer network associated with a provider of locks by way of a web page;
providing access information specific to an end user necessary to access information in said remote database; and
receiving information related to a lock from said database;
providing updated information for said lock; and
storing said updated information in said database.

29. A method of communicating lock information stored in a remote database, said method comprising the steps of:
generating a combination for a lock;
storing said combination in said remote database;
providing access to an end user to said remote database by way of a computer network upon receiving access information specific to said end user; and
providing to said end user said lock information from said database.

30. The method of claim 29 wherein the step of generating a combination for a lock comprises generating a random combination.

31. The method of claim 29 further comprising a step of entering and storing information specific to said lock.

32. The method of claim 31 wherein said information specific to said lock comprises information selected from the group consisting of:
a combination;
a serial number;
a model number;
a lock type;
a time delay;
an open period;
a time lock;
a master reset code;
a programmer code;
user codes;
the location of the lock on the safe; and
the date the information was entered in the database.

33. The method of claim 29 further comprising a step of updating said combination with a new combination received from said end user.

34. The method of claim 29 wherein said step of providing access to an end user comprises providing access to a web page associated with said computer network.

35. A method of communicating lock information, said method comprising the steps of:
maintaining a database of lock information;
receiving compensation from at least one end user for the right to access said database;
providing access to said database to said at least one end user; and
providing information related to a lock in response to a request from said at least one end user.

36. The method of claim 35 wherein said step of maintaining comprises generating, storing and updating a lock combination for said at least one user.

37. A system for communicating lock information stored in a database, said system comprising:
a first terminal coupled to a communication network;
a database associated with said first terminal for storing said lock information; and
a second terminal in communication with said first terminal by way of said communication network for accessing said lock information.

38. The system of claim 37 wherein said lock information comprises a lock combination generated at said first terminal.

39. The system of claim 38 wherein said lock combination comprises a randomly generated combination which can be overridden if said randomly generated combination is inconsistent with parameters associated with said lock.

40. The system of claim 37 wherein said lock combination comprises a user selected combination transmitted from said second terminal to said database by way of said communication network.

41. The system of claim 37 wherein said lock information comprises a lock combination which is manually entered at said first terminal.

42. The system of claim 37 wherein said lock information comprises information selected from the group consisting of:
a combination;
a serial number;
a model number;
a lock type;
a time delay;
an open period;
a time lock;
a master reset code;
a programmer code;
user codes;
the location of the lock on the safe; and
the date the information was entered in the database.

43. The system of claim 37 wherein said database stores a new combination received from said end user of said lock by way of said communication network.
